(19) United States
(12) Patent Application Publication
(10) Pub. No.: US 2024/0338581 A1
(43) Pub. Date: Oct. 10, 2024

(54) System and Method for Supporting RDF/OWL Forward Chaining and Hidden Facts Prediction in Property Graph

(71) Applicant: INTERNATIONAL BUSINESS MACHINES CORPORATION, ARMONK, NY (US)

(72) Inventors: Sumit Neelam, Agra, NY (US); Hima Prasad Karanam, Bangalore (IN); Udit Sharma, Shimla (IN); Shajith Ikbal Mohamed, Chennai (IN); L. Venkata Subramaniam, Guragon (IN)

(21) Appl. No.: 18/296,248

(22) Filed: Apr. 5, 2023

(51) Int. Cl. G06N 5/04; G06N 5/02

(52) U.S. Cl. CPC G06N 5/04; G06N 5/02

(57) ABSTRACT

A method implemented by a system for performing forward chaining using a property graph, the method includes generating, from an ontology, a simplified ontology that includes a set of sub-conditions connected through logical operators that are equivalent to the ontology. A state graph is created based on the simplified ontology. When a first assertion axiom (ABox) statement associated with the ontology is received, the first ABox statement is added to an instance graph based on the state graph. Inferred statements, if any, are derived based on connections between the instance graph and the state graph. The inferred statements are then stored with the first ABox statement. The state graph and the first ABox statement are stored in the property graph.

### BACKGROUND

The Resource Description Framework (RDF) and Web Ontology Language (OWL) are ontology languages for representing information about resources in the World Wide Web. Ontologies, also referred to as semantic data models, are formalized vocabularies of terms, often covering a specific domain. They specify the definitions of terms by describing their relationships with other terms in the ontology (e.g., by defining the types/classes of things that exist in the domain, the properties/attributes of the defined classes of things, and the relationships/properties that connect two classes). An ontology entity represents a conceptual element of the domain. An ontology entity is an individual subject or object of ABox. In RDF, ABox is typically in the form of triple <E1, P, E2>, where E1 is a first entity and E2 is a second entity and P is the predicate indicate the relationship between E1 and E2.

RDF is intended for situations in which information needs to be processed by applications, rather than being only displayed to people. For example, RDF can also be used to represent information about things that can be identified on the Web, even when they cannot be directly retrieved on the Web. Examples include information about items available from on-line shopping facilities (e.g., information about specifications, prices, and availability), or the description of a Web user's preferences for information delivery. RDF provides a common framework for expressing this information so it can be exchanged between applications without loss of meaning. RDF is based on the idea of identifying things using Web identifiers (called Uniform Resource Identifiers, or URIs), and describing resources in terms of simple properties and property values. This enables RDF to represent simple statements about resources as a graph of nodes and arcs representing the resources, and their properties and values.

OWL is a knowledge representation language used on the Semantic Web, which semantically extends RDF. OWL facilitates greater machine interpretability of Web content than that supported by Extensible Markup Language (XML), RDF, and RDF Schema (RDF-S) by providing additional vocabulary along with a formal semantics. In other words, RDF is used to describe resources and their relationships, while OWL is used to create ontologies and define the concepts and relationships between them. RDF and OWL can be used together to create more sophisticated models and to reason over data. For example, an ontology created in OWL can be used to classify resources described in RDF and to reason about relationships between them. OWL can also be used to create rules that can be applied to RDF data, such as to detect inconsistencies or to infer new relationships.

A Property Graph is a data model used in graph databases to represent and store data in a graph format. In this model, data is represented as nodes and relationships between nodes, where both nodes and relationships can have properties (key-value pairs) attached to them. A node represents an entity, and can have one or more labels that define its type. Relationships in a property graph represent the connections between nodes. Relationships can also have properties attached to them, such as the time the relationship was created. For example, a relationship labeled “PostedBy” might connect a user node to a post node, indicating that the user created the post. The property graph model allows for flexible and efficient querying and manipulation of data, making it well-suited for use in graph databases. It is widely used in various applications such as social networks, recommendation systems, and network analysis.

### SUMMARY

Embodiments of the present disclosure includes a method, a system, and a computer program product configured to perform incremental forward chaining using a property graph. In an embodiment, an ontology is decomposed into a set of sub-conditions connected through logical operators (referred to herein as a simplified ontology). A state graph is created based on the simplified ontology. Using the state graph, a graph created from ABox (referred to as an instance graph) is incrementally updated for each assertion axiom (ABox) statement associated with the ontology. Inferred statements, if any, are derived based on connections between the instance graph and the state graph. The inferred statements are stored in the corresponding ABox statement, which is stored with the state graph in the property graph.

As an example embodiment, a method implemented by a system for performing forward chaining is disclosed. The method includes generating, from an ontology, a simplified ontology comprising a set of sub-conditions connected through logical operators that are equivalent to the ontology; creating a state graph based on the simplified ontology; receiving a first assertion axiom (ABox) statement associated with the ontology; adding the first ABox statement to an instance graph based on the state graph; deriving one or more first inferred statements based on connections between instance graph and the state graph; storing the one or more first inferred statements with the first ABox statement; and storing the state graph and the first ABox statement in the property graph.

### BRIEF DESCRIPTION OF DRAWINGS

For a more complete understanding of this disclosure, reference is now made to the following brief description, taken in connection with the accompanying drawings and detailed description, wherein like reference numerals represent like parts.

FIG. 1 is a schematic diagram illustrating a process for performing incremental forward chaining in accordance with an embodiment of the present disclosure;

FIG. 2 is a diagram illustrating an example of an ontology in accordance with an embodiment of the present disclosure;

FIG. 3 is a diagram illustrating a process for creating a state graph in accordance with an embodiment of the present disclosure;

FIG. 4 is a diagram illustrating a state graph in accordance with an embodiment of the present disclosure;

FIG. 5 is a diagram illustrating a simplified ontology in accordance with an embodiment of the present disclosure;

FIG. 6 is a diagram illustrating a graph in accordance with an embodiment of the present disclosure;

FIG. 7 is a diagram illustrating a graph in accordance with an embodiment of the present disclosure;

FIG. 8 is a diagram illustrating a graph in accordance with an embodiment of the present disclosure;

FIG. 9 is a diagram illustrating a state graph for determining hidden facts in accordance with an embodiment of the present disclosure;

FIG. 10 is a flowchart illustrating a method implemented by a system for performing forward chaining in accordance with an embodiment of the present disclosure;

FIG. 11 is a schematic diagram illustrating a system in accordance with an embodiment of the present disclosure;

The illustrated figures are only exemplary and are not intended to assert or imply any limitation with regard to the environment, architecture, design, or process in which different embodiments may be implemented.

### DESCRIPTION OF EMBODIMENTS

The present disclosure provides various systems and methods for supporting incremental RDF/OWL forward chaining and hidden facts prediction in property graph. Although RDF and OWL are described in the various embodiments, the present disclosure and the scope of the claims, unless explicitly recited in the claims, are not intended to be limited by the example embodiments. For example, the present disclosure and the scope of the claims may cover other versions of OWL (e.g., OWL version 2 (OWL2), OWL Lite, OWL description logics (OWL DL), and OWL Full) or other semantic/ontology languages.

A reasoning system is a system that generates conclusions from available knowledge using logical techniques such as deduction and induction. Reasoning systems play an important role in the implementation of artificial intelligence and knowledge-based systems. Reasoning systems can utilize RDF/OWL reasoning to infer logical consequences from a set of asserted facts. For example, RDF/OWL knowledge base contains two types of logical statements, terminological axiom (TBox) statements and assertion axiom (ABox) statements. TBox statements describe a domain of interest by defining classes and properties as a domain vocabulary. TBox statements are more fixed within a knowledge base and are used and stored as a schema or a data model. ABox are TBox-compliant statements that use the vocabulary. ABox statements are also called base facts. TBox statements are sometimes associated with object-oriented classes and ABox statements are associated with instances of those classes. For example, a TBox statement may define woman as a subclass of human, and an ABox statement may assert that Angelina Jolie is a member of the woman subclass. ABox statements are not as fixed as TBox statements and can be used to store additional information such as an inferred knowledge/statement. An inferred statement is a new relationship or fact that is based on the state graph and based on logical rules. As a simple example, if A is in B, and B is in C, then it can be inferred that A is in C. The inferred statements are then stored with the ABox statement for use in responding to future queries.

In common reasoning systems, infer knowledge may be determined by either forward and backward chaining. In the backward chaining, ABox statements are stored in a database backend and TBox data is used by the reasoning system to infer knowledge at query time (i.e., when a query is received). This increases the query response time. To reduce query response time, inferred statements can be computed upfront and stored with original ABox statements, this process is referred as forward chaining. However, in currently available systems, inferred statements for performing forward chaining are obtained through external reasoning engines. ABox statements are passed to reasoning engine which uses TBox data to get inferred statements. In the case, when system is update intensive or when input data arrive in batches, collecting inference statements can be a difficult time-consuming task that requires re-running the whole inference process to collect all the relevant ABox data.

To address the above issues, present disclosure provides various systems and methods for supporting incremental RDF/OWL forward chaining and hidden facts prediction in property graph. As an example, the present disclosure provides a novel method of reasoning using forward chaining in knowledge graph by turning an ontology into a state machine, which is simplified and stored as a graph. In particular, the disclosed embodiments are configured to derive inferred knowledge/facts incrementally during graph building using the graph schema architecture for efficient inference computations.

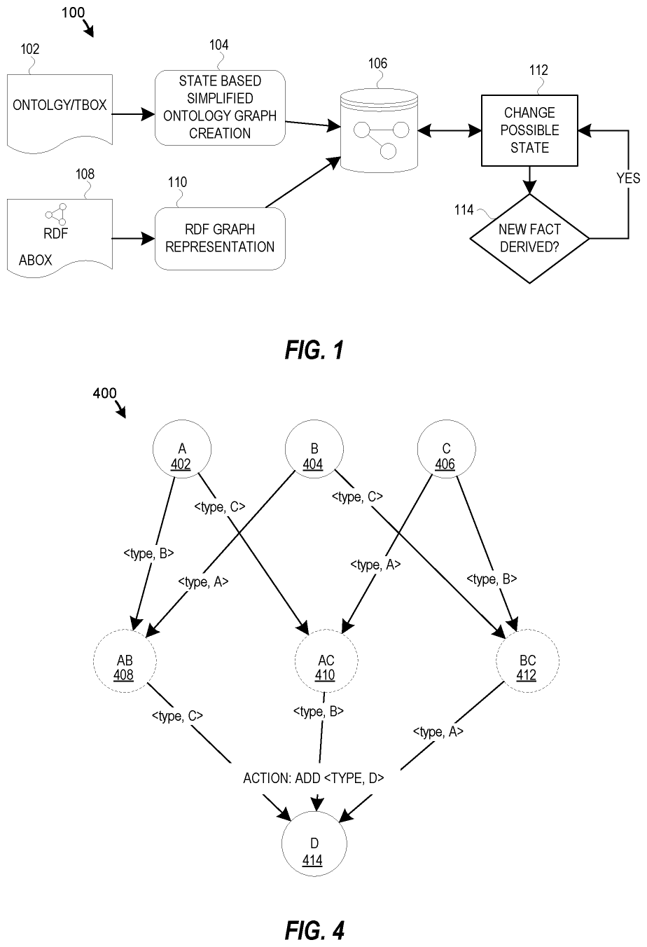

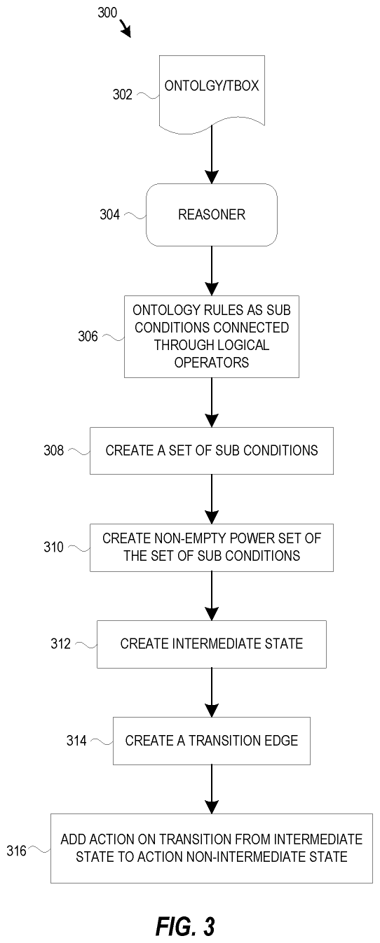

FIG. 1 is a schematic diagram illustrating a process 100 for performing incremental forward chaining of RDF/OWL data using a property graph in accordance with an embodiment of the present disclosure. In general, an ontology/TBox statement 102 is passed to a state based simplified ontology graph creation process 104 that is configured to generate a state based simplified ontology graph 106 (i.e., a state graph) based on the ontology/TBox statement 102. As stated above, the TBox statement 102 describes a domain of interest by defining classes and properties as a domain vocabulary. An example of a TBox statement 102 is the TBox statement 200 shown below. An example of the state based simplified ontology graph creation process 104 is shown and described in FIG. 3. The state based simplified ontology graph 106 is stored in a knowledge base or data base.

To perform incremental forward chaining, the process 100 processes one ABox statement 108 at a time. An RDF graph representation process 110 applies the facts (commonly referred to as base facts) specified in the ABox statement 108 to an instance graph based on the state based simplified ontology graph 106. An instance graph, also known as an instance data graph or instance model, is a specific instance of a data model, in this case the state based simplified ontology graph 106, that represents data in the form of a graph. In other words, it is a concrete representation of the state based simplified ontology graph 106, showing actual data values rather than just the structure of the model. Instance graphs can be thought of as a snapshot of the data at a particular point in time. As new data is added or updated, the instance graph will change to reflect those updates.

Once the ABox statement 108 is added to the instance graph, the process 100, at 112, determines whether the states of any entities in the state based simplified ontology graph 106 have changed. As stated above, an entity is an individual subject or object of ABox. As will be further described, the states for an entity is the set of classes (direct and derived) an entity is connected in the state graph. The states of an entity X change when entity X includes a state Sᵢ, and after adding the base facts of the ABox statement 108 to the instance graph, the state Sᵢ satisfies the edge constraints on outgoing edge landing in a second state Cᵢ, then the second state Cᵢ is added to the states of entity X and appropriate edges will get added. When the states of an entity in the state based simplified ontology graph 106 changes, the process 100, at 114, determines whether new inferred fact(s) can be derived from the state change based on the connections between the instance graph and the state based simplified ontology graph 106, and if so, then additional edges are inserted for the new inferred fact(s). The new inferred fact(s) is then stored with the ABox statement 108 for forward chaining. The state graph and the ABox statement is stored in property graph.

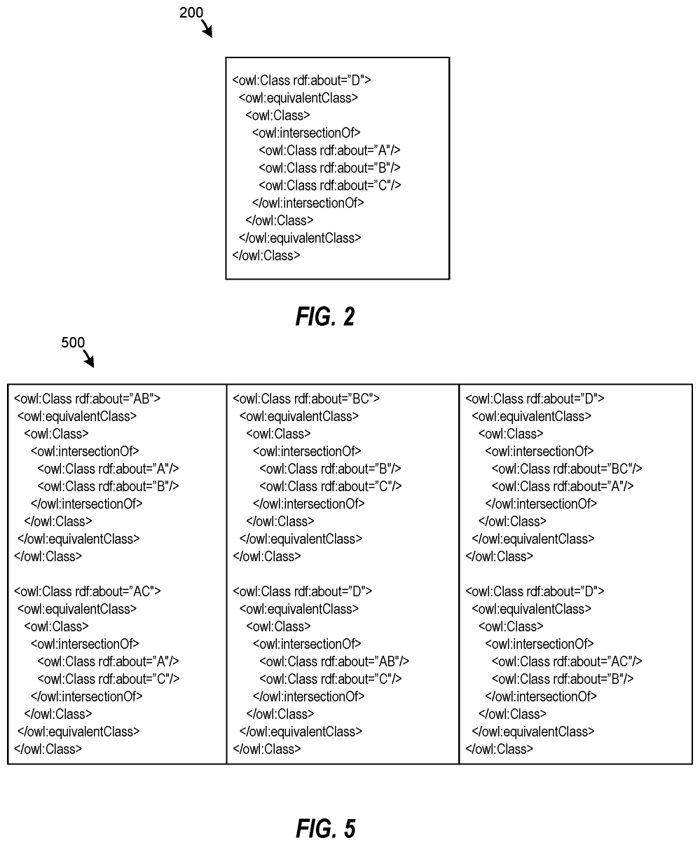

FIG. 2 is a diagram illustrating an example of an ontology 200 in accordance with an embodiment of the present disclosure. The ontology 200 is an example of an ontology that can be used as the TBox statement 102 described in FIG. 1. The ontology 200, using RDF/OWL, defines a Class D that is equivalent to the intersection of a Class A, a Class B, and a Class C.

FIG. 3 is a diagram illustrating a process 300 for creating a state graph in accordance with an embodiment of the present disclosure. As stated above, the process 300 is an example of the state based simplified ontology graph creation process 104 described in FIG. 1. The process 300 starts with an ontology/TBox 302 that is passed to (i.e., input into) a reasoner 304. The reasoner 304 is a semantic reasoner, reasoning engine, or rules engine configured to infer logical consequences from a set of asserted facts or axioms. For example, automated reasoners such as Protégé, Pellet, FaCT++, HerMIT, and ELK take a collection of axioms written in OWL and offer a set of operations on the ontology's axioms. The disclosed embodiments are not limited to any particular reasoner. Thus, in accordance with the disclosed embodiments, the reasoner outputs ontology rules as a set of sub conditions connected through logical operators. For example, inputting ontology 200 of FIG. 2 into a reasoner may generate the following output:

Class D

‘Class D’ rdfs:label “Class D”
Class: ‘Class D’
Class D’ EquivalentTo ‘Class A’ and ‘Class B’ and ‘Class C’

The above output includes the set of sub conditions (‘Class A’, ‘Class B’, ‘Class C’) that are connected through the logical (AND) operator. The logical AND operator (&) returns true if both operands are true and returns false otherwise. This operator can be used to find the intersection between two classes. Intermediate states are required for sub conditions connected through logical AND.

At step 308, the process 300 creates a set S={A1, A2, . . . , An} of the sub conditions. For instance, using the above example, the set S={A, B, C} is created. At step 310, the process 300 creates a non-empty power set P(S) of the set S (i.e., P(S)={{A1}, {A2}, . . . , {An}, {A1, A2}, . . . } comprising the combinations of the sub conditions in the set S. For example, using the above example, the P(S)={{A}, {B}, {C}, {A,B}, {A,C}, {B,C}, {A,B,C}} is created.

At step 312, the process 300 creates intermediate state for each element in P(S) if the intermediate state does not exist in the state graph. The intermediate state forms a path from an original state/classes {A, B, C} of the ontology specified in the ontology/TBox statement to an action state {D}. An action state is a state that instructs to perform an inference (i.e., an inferred fact). To create an intermediate state, the process 300 determines a set of states (M, N) in the set P(S), where the difference the cardinality of (N-M) is 1 and state M is in state N (i.e., M⊂N). The cardinality is the number of elements in a state. For each set of states (M, N), the process 300, at step 314, adds a transition edges and a transition edge condition between state N and state M. For instance, using the above example, the process 300 creates intermediate state A, B (or AB) and adds a transition edge from original state A to the AB because the cardinality of AB-A is 1, and state A is in state AB. The process 300 also adds transition edge condition <type, B> to the transition edge from state A to state AB indicating the condition required to transition from state A to state AB. Using the same process, the process 300 creates intermediate state AC and BC along with adding transition edges and their edge condition.

The process 300, at step 316, then adds an action on transition from an intermediate state to any non-intermediate states, excluding the original states, referred to herein as an action state. For instance, using the above example, for action state D, which is equivalent to the intersection of states A, B, and C, the process 300 adds “Action: Add <type, D>” for transitions from an intermediate state to action state D. When an intermediate state (e.g., state AB) transitions to action state D, the action is performed.

FIG. 4 is a diagram illustrating a state graph 400 in accordance with an embodiment of the present disclosure. The state graph 400 is an example of the state based simplified ontology graph 106 described in FIG. 1. The state graph 400 represents a state graph created using the ontology 200 of FIG. 2 in accordance with the process 300 described in FIG. 3. In the state graph 400, the original ontology classes/states A 402, B 404, C 406, and action state D 414 are shown using solid circles and the intermediate classes/states AB 408, AC 410, and BC 412 are shown as dotted circles. As stated above, the intermediate states form path from the original ontology classes to the action state. The transition condition required to transition from one state to another state is indicated on the transition edge connecting the states. For example, to transition from state A 402 to state ABox 408 an ABox statement <x type B> is added when x is currently in state A 402. Similar, when ABox statement <x type C> is added and x is currently in state AB 408, state AB 408 transitions to state D 414. The state graph 400 indicates the action to perform when action state D 414 is reached (i.e., transitions to).

FIG. 5 is a diagram illustrating an ontology 500 of the state graph 400 in accordance with an embodiment of the present disclosure. As stated above, during ontology simplification, the original ontology/TBox statement rules are simplified or decomposed to into subcomponents or sub-conditions, and new intermediate classes/states are added. The simplified ontology is transformed into a state graph. This state graph, as shown in FIG. 4, represents nodes as states and edges connect states with conditions required for state transition. As described above, the states for an entity is the set of classes (direct and derived) an entity is connected in the state graph. A state transition occurs when an entity X is in one state, and after adding an ABox fact, if the state satisfies the edge constraints on outgoing edge to a second state, then the second state will be added to the states of the entity X.

The ontology 500 describes the properties of the new nodes (AB, BC, AC, and D) in FIG. 4 that is created during the process 300 of FIG. 3 when the state graph is being generated. The ontology 500 may be stored in a database as part of the state graph. In particular, the ontology 500 shows the class definitions for the new intermediate classes AB (defined as being equivalent to the intersectionOf class A and class B), AC (defined as being equivalent to the intersectionOf class A and class C), and BC (defined as being equivalent to the intersectionOf class B and class C). The ontology 500 also includes 3 class definitions for class D (defined as being equivalent to the intersectionOf class AB and class C, equivalent to the intersectionOf class BC and class A, and equivalent to the intersectionOf class AC and class B.

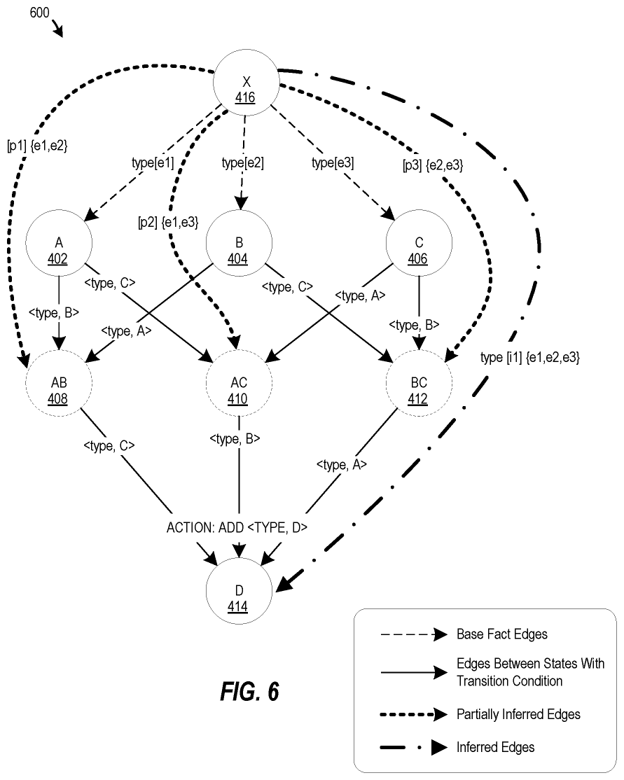

FIG. 6 is a diagram illustrating a graph 600 after adding an ABox statement to an instance graph based on the state graph 400 of FIG. 4 in accordance with an embodiment of the present disclosure. As described in FIG. 1, once the state graph is initially created from the ontology/TBox statement 102 using, for example, the process 300 described in FIG. 3, the facts of an ABox statement 108 are then added to an instance graph based on the state graph during an update process as represented by the RDF graph representation process 110 in FIG. 1. In the depicted embodiment of FIG. 6, an ABox statement that includes the following ABox base facts are added to the state graph 400 of FIG. 4.

| ABox Base Facts | Graph Edge ID |
|---|---|
| <x> type <A> | e1 |
| <x> type <B> | e2 |
| <x> type <C> | e3 |

In particular, for incremental forward chaining, the following step are performed for each ABox fact <E1, P, E2> during the update process. First, the base fact(s) is/are added to an instance graph based on the state graph for corresponding nodes of entity E1 and E2. As shown in the graph 600, entity X 416 and the condition (type [e1]) to transition from entity X 416 to state A 402 according to the first base fact is added to the state graph 400, the condition (type [e2]) to transition from entity X 416 to state B 404 according to the second base fact is added, and the condition (type [e3]) to transition from entity X 416 to state C 406 according to the third base fact is added.

The process determines the set of states (S1) of entity E1 and the set of states (S2) of entity E2. The process iterates over each state s in S1 and each state s in S2 to find edges e (s, t) in the graph 600 that satisfies the edge transition condition of e. For each edge transition condition of e that is satisfied, the process adds the state t to the states of entity E1 (if state s is in S1) and to the states of entity E1 (if state s is in S2). If t is an action state; the process adds an inferred statement based on action on t to the ABox statement.

For example, because the set of states S1 of entity X 416 includes state A 402, state B 404, and state C 406 when the base facts of the ABox statement are added to an instance graph, iterating over each state s in S1 adds states AB 408, AC 410, BC 412, and D 414 to the set of states S1 of entity X 416. For instance, when x is in state A 402, the entity X 416 includes the ABox statement <x> type <B> (i.e., base fact 2) and thus satisfies the edge transition condition from state A 402 to state AB 408. Therefore, state AB 408 is added to the set of states S1 of entity X 416. Similarly, when x is in state AB 408, the entity X 416 includes the ABox statement <x> type <C> (base fact 3) and thus satisfies the edge transition condition from state AB 408 to state D 414, and state D 414 is added to the set of states S1 of entity X 416. When the process transitions to state D 414, because state D 414 is an action state, the process performs the action associated with state D 414 and adds <x> type <D> to the ABox statement. This fact is referred to as inferred or derived fact based on the existing facts and logical rules. The logical rule for deriving this inferred fact is the intersection rule of ontology: x∈{A, B, C} then x∈D. An inferred transition edge and edge condition from entity X to state D 414 is illustrated in the graph 600. The edge condition is type [i] {e1, e2, e3}. The semantics of edge condition/property is edge-label [edge-id] {dependency on edges}. Thus, in above edge condition, type is the edge-label, i1 is the edge-id, and e1, e2, e3 are dependency edges (i.e., this edge requires/depends on edges e1, e2, e3 existing). Thus, the set of states S1 of entity X 416 after adding the ABox statement in this example is {A, B, AB, C, AC, BC, D}. Additionally, in some embodiments, for completing multiple steps, we use the graph 600 to store partially inferred information. For example, partially inferred edges (e.g., from the entity X 416 to state AB 408, to state AC 410, and state BC 412) and their corresponding edge conditions may be added to the graph 600 as shown in FIG. 6. Partially inferred edges indicate the relationship between entity X 416 and intermediate/non-action states. Storing partially inferred information using the graph 600 is unlike existing RDF reasoning systems which use exploration algorithm on ABox facts to compute closure (all the possible inferred statements). As further described below, in some embodiments, partially inferred information is used for predicting hidden facts based on earlier statistics to suggest missing facts. A hidden fact is a probable future inferred statement as determined by the statistics.

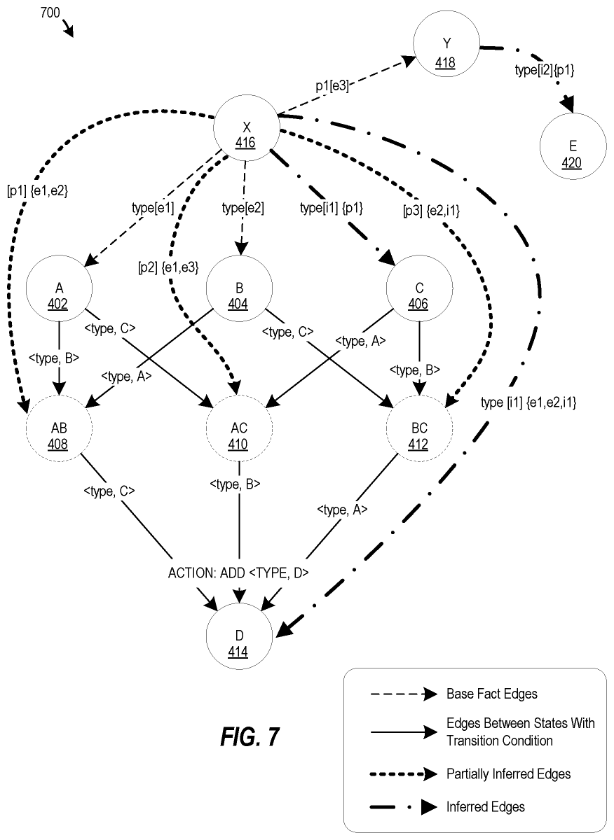

FIG. 7 is a diagram illustrating a graph 700 after adding a different ABox statement to an instance graph based on the state graph 400 of FIG. 4 in accordance with an embodiment of the present disclosure. In this embodiment, the ABox statement include the following ABox base facts to be added to an instance graph.

| ABox Base Facts | Graph Edge ID |
|---|---|
| <x> type <A> | e1 |
| <x> type <B> | e2 |
| <x> p1 <y> | e3 |

As described above, for incremental forward chaining, the following step are done for each ABox fact <E1, P, E2>. First, the base fact(s) is/are added to the instance graph for corresponding nodes of entity E1 and E2. As shown in the graph 700, entity X 416 and the condition (type [e1]) to transition from entity X 416 to state A 402 according to the first base fact is added to the instance graph, then condition (type [e2]) to transition from entity X 416 to state B 404 according to the second base fact is added to the instance graph, and then condition (p1[e3]) to transition from entity X 416 to entity Y 406 according to the third base fact is added to the instance graph.

For the third base fact, the ontology for property p1 is given as: {<p1> domain <C>; <p1> range <E>}. In RDF, the domain and range properties indicate how the property (<C> and <E> in the given base fact) links a subject (<x> in the given base fact) to an object (<y> in the given base fact). The domain property links the property <C> to the subject <x>, and the range property links the property <E> to the subject <y>. Thus, based on the ontology for property p1, the following inferred facts can be derived: inferred fact 1 (i1): <x> type <C> based on <p1> domain <C>, and inferred fact 2 (i2): <y> type <E> based on <p1> range <E>. The above two inferred facts and their corresponding edge conditions are added to the instance graph. For example, entity X 416 transitions to state C 406 based on edge condition type [i1] {p1}, and entity Y 418 transitions to state E 420 based on edge condition type [i2] {p1}. Additionally, a third inferred fact 3 (i3): <x> type <D> is derived from the intersection rule of ontology: x∈{A, B, C} then x∈D.

Thus, after adding the base facts of the ABox statement given in this example and the three derived facts (i1, i2, and i3), the set of states S1 of entity X 416 is {A, B, AB, C, AC, BC, D} and the set of states S2 of entity Y 418 {E}.

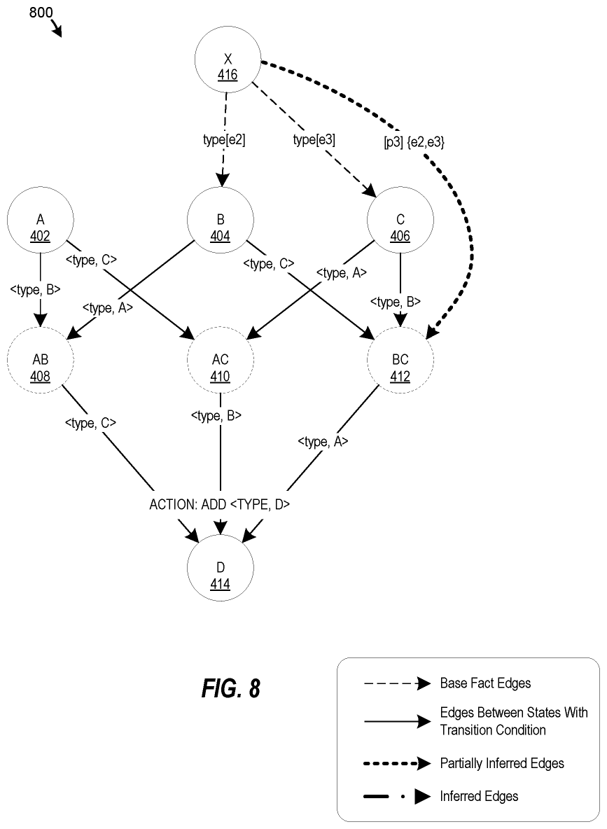

FIG. 8 is a diagram illustrating a graph 800 after adding another ABox statement to the graph 600 of FIG. 6 in accordance with an embodiment of the present disclosure. In this example, the ABox statement include the following ABox base fact to be deleted to the graph 600 of FIG. 6.

| ABox Base Facts | Graph Edge ID |
|---|---|
| <x> type <A> | e1 |

In applying the above base fact, the edge connecting the entity X 416 to state A 402 is removed/deleted, which results in the partially inferred edges from the entity X 416 to state AB 408 and from the entity X 416 to state AC 410 to be removed. Additionally, the previously inferred fact <x> type <D> is removed along with its corresponding edge since the intersection rule of ontology: x∈{A, B, C} then x∈D is no longer satisfied. After applying the above base fact, the set of states S1 of the entity X 416 is now {B, C, BC}.

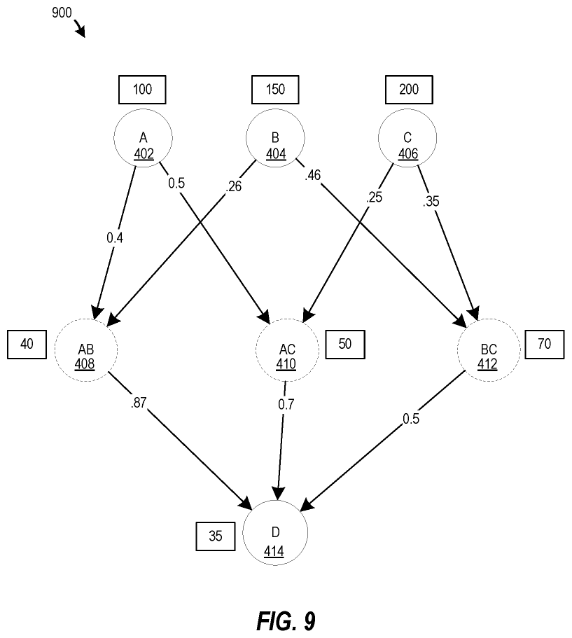

FIG. 9 is a diagram illustrating statistical values associated with the state graph 400 of FIG. 4 for determining hidden facts in accordance with an embodiment of the present disclosure. In an embodiment, the process for determining hidden facts may be part of the state based simplified ontology graph creation process 104 in FIG. 1. When the state graph is created, the process can determine hidden facts based on statistical probabilities.

In the depicted embodiment, the number adjacent the nodes in the state graph 400 indicate the number of fact nodes connected to each class. The values on the transition edges between nodes is a weight indicating a probability of transitioning from a state/node to a connected state/node. Edges with higher weight have a higher probability of transition. For instance, in the illustrated example, the edge between state AB 408 and state D 414 has 0.87 weight. This means that if a fact has reached state AB 408, then there is high chance that the fact will reach state D 414. Based on these given statistical probabilities, a hidden fact can be determined that probably x∈C because AB=A∩B and D=A∩B∩C, and if x∈A∩B then x∈C (probable statement).

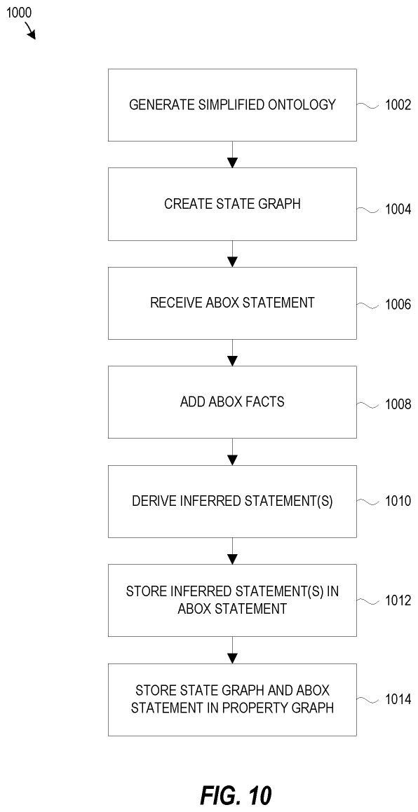

FIG. 10 is a flowchart illustrating a method 1000 implemented by a system for performing forward chaining in accordance with an embodiment of the present disclosure.

At step 1002, the system generates a simplified ontology from an ontology/TBox statement. In an embodiment, the simplified ontology includes a set of sub-conditions connected through logical operators that are equivalent to the ontology. In an embodiment, the simplified ontology is generated by passing the ontology/TBox statement to a reasoner to generate the set of sub conditions connected through logical operators.

At step 1004, the system creates a state graph based on the simplified ontology. In an embodiment, the process for creating the state graph includes creating a non-empty power set of the set of sub conditions, and creating one or more intermediate states for each element in the non-empty power set. Additionally, one or more transition edges and transition edge condition are added between a first state N and a second state M when a first cardinality of the first state (cardinality (N)) is equal to a second cardinality of the second state plus 1 (cardinality (M)+1) and the second state M is in the first state N(M⊂N). An action associated with the action state when the one or more intermediate states transitions to the action state is added to the state graph.

At step 1006, the system receives an ABox statement associated with the ontology. The ABox statement (or ABox facts), at step 1008, is/are added to an instance graph based on the state graph. For example, a fact corresponding to a first entity and a second entity of the ABox statement is first added to an instance graph. In an embodiment, a first set of states of the first entity and a second set of states of the second entity is determined. For each state in the first set of states and the second set of states, the system determines whether the state satisfies an edge transition condition to second state in the instance graph, and if so, adds the second state to the first set of states (when the state is in the first set of states) or adds the second state to the first set of states (when the state is in the second set of states).

In an embodiment, at step 1010, the system derives one or more inferred statements based on connections between the instance graph and the state graph after the ABox facts are added. The process of deriving facts using forward chaining may depend on sets of ABox base facts and may be performed in a single step or may require multiple steps between states for forward chaining. For instance, for OWL2 existential logic (EL) profile axioms, a single step is sufficient between states for forward chaining for ClassExpression:=ObjectOneOf and ClassExpression:=ObjectHasValue, while multiple steps are required ClassExpression:=ObjectIntersectionOf and ClassExpression:=ObjectSomeValuesFrom.

At step 1012, the system stores the one or more first inferred statements with the ABox statement. The system, at step 1014, stores the state graph and the ABox statement in the property graph. The steps of 1008-1014 are repeated for each additional ABox statement associated with the ontology that is received by the system for performing incremental forward chaining and determining hidden facts as disclosed herein.

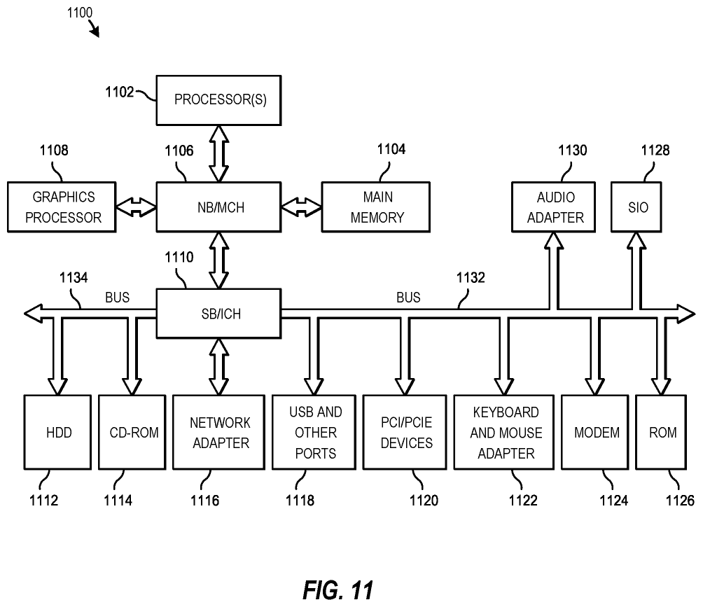

FIG. 11 is a block diagram illustrating a hardware architecture of a system 1100 according to an embodiment of the present disclosure in which aspects of the illustrative embodiments may be implemented. For example, in an embodiment, the method 1000 in FIG. 10 may be implemented using the data processing system 1100. In the depicted example, the data processing system 1100 employs a hub architecture including north bridge and memory controller hub (NB/MCH) 1106 and south bridge and input/output (I/O) controller hub (SB/ICH) 1110. Processor(s) 1102, main memory 1104, and graphics processor 1108 are connected to NB/MCH 1106. Graphics processor 1108 may be connected to NB/MCH 1106 through an accelerated graphics port (AGP). A computer bus, such as bus 1132 or bus 1134, may be implemented using any type of communication fabric or architecture that provides for a transfer of data between different components or devices attached to the fabric or architecture.

In the depicted example, network adapter 1116 connects to SB/ICH 1110. Audio adapter 1130, keyboard and mouse adapter 1122, modem 1124, read-only memory (ROM) 1126, hard disk drive (HDD) 1112, compact disk read-only memory (CD-ROM) drive 1114, universal serial bus (USB) ports and other communication ports 1118, and peripheral component interconnect/peripheral component interconnect express (PCI/PCIe) devices 1120 connect to SB/ICH 1110 through bus 1132 and bus 1134. PCI/PCIe devices may include, for example, Ethernet adapters, add-in cards, and personal computing (PC) cards for notebook computers. PCI uses a card bus controller, while PCIe does not. ROM 1126 may be, for example, a flash basic input/output system (BIOS). Modem 1124 or network adapter 1116 may be used to transmit and receive data over a network.

HDD 1112 and CD-ROM drive 1114 connect to SB/ICH 1110 through bus 1134. HDD 1112 and CD-ROM drive 1114 may use, for example, an integrated drive electronics (IDE) or serial advanced technology attachment (SATA) interface. In some embodiments, HDD 1112 may be replaced by other forms of data storage devices including, but not limited to, solid-state drives (SSDs). A super I/O (SIO) device 1128 may be connected to SB/ICH 1110. SIO device 1128 may be a chip on the motherboard configured to assist in performing less demanding controller functions for the SB/ICH 1110 such as controlling a printer port, controlling a fan, and/or controlling the small light emitting diodes (LEDS) of the data processing system 1100.

The data processing system 1100 may include a single processor 1102 or may include a plurality of processors 1102. Additionally, processor(s) 1102 may have multiple cores. For example, in one embodiment, data processing system 1100 may employ a large number of processors 1102 that include hundreds or thousands of processor cores. In some embodiments, the processors 1102 may be configured to perform a set of coordinated computations in parallel.

An operating system is executed on the data processing system 1100 using the processor(s) 1102. The operating system coordinates and provides control of various components within the data processing system 1100 in FIG. 11. Various applications and services may run in conjunction with the operating system. Instructions for the operating system, applications, and other data are located on storage devices, such as one or more HDD 1112, and may be loaded into main memory 1104 for execution by processor(s) 1102. In some embodiments, additional instructions or data may be stored on one or more external devices. The processes described herein for the illustrative embodiments may be performed by processor(s) 1102 using computer usable program code, which may be located in a memory such as, for example, main memory 1104, ROM 1126, or in one or more peripheral devices.

The disclosed embodiments may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random-access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the disclosed embodiments are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented method, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. Further, the steps of the methods described herein may be carried out in any suitable order, or simultaneously where appropriate. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method implemented by a system for performing forward chaining of Resource Description Framework (RDF) and Web Ontology Language (OWL) data using a property graph, the method comprising:
generating, from an ontology, a simplified ontology comprising a set of sub-conditions connected through logical operators that are equivalent to the ontology;
creating a state graph based on the simplified ontology;
receiving a first assertion axiom (ABox) statement associated with the ontology;
adding the first ABox statement to an instance graph based on the state graph;
deriving one or more first inferred statements based on connections between the instance graph and the state graph;
storing the one or more first inferred statements with the first ABox statement; and
storing the state graph and the first ABox statement in the property graph.

2. The method of claim 1, further comprising predicting one or more hidden facts based on statistics associated with the state graph, wherein a hidden fact is a probable future inferred statement as determined by the statistics.

3. The method of claim 1, wherein generating, from the ontology, the simplified ontology comprises passing the ontology to a reasoner to generate the set of sub conditions connected through logical operators.

4. The method of claim 1, wherein creating the state graph based on the simplified ontology comprises:
creating a non-empty power set of the set of sub conditions;
creating one or more intermediate states for each element in the non-empty power set, wherein the intermediate states form a path from an original state of the ontology to an action state;
adding one or more transition edges and transition edge condition between a first state N and a second state M when a first cardinality of the first state (cardinality (N)) is equal to a second cardinality of the second state plus 1 (cardinality (M)+1) and the second state M is in the first state N(M⊂N); and
adding an action associated with the action state when the one or more intermediate states transitions to the action state.

5. The method of claim 1, wherein adding the first ABox statement to the instance graph based on the state graph comprises:
applying a fact corresponding to a first entity and a second entity of the first ABox statement;
determining a first set of states of the first entity and a second set of states of the second entity;
for each state in the first set of states and the second set of states, determining whether the state satisfies an edge transition condition to second state in the state graph;
adding the second state to the first set of states when the state is in the first set of states and satisfies the edge transition condition to the second state; and
adding the second state to the second set of states when the state is in the second set of states and satisfies the edge transition condition to the second state.

6. The method of claim 5, wherein deriving the one or more first inferred statements based on the connections between the instance graph and the state graph comprises adding an inferred statement based on an action associated with the second state when the second state is an action state.

7. The method of claim 1, further comprising:
receiving a second ABox statement associated with the ontology;
adding the second ABox statement to the instance graph;
deriving one or more second inferred statements based on the connections between the instance graph and the state graph;
storing the one or more second inferred statements with the second ABox statement; and
storing the second ABox statement in the property graph.

8. A system comprising:
a memory configured to store instructions; and
a processor coupled to the memory and configured to execute the instructions to cause the system to:
generate, from an ontology, a simplified ontology comprising a set of sub-conditions connected through logical operators that are equivalent to the ontology;
create a state graph based on the simplified ontology;
receive a first assertion axiom (ABox) statement associated with the ontology;
add the first ABox statement to an instance graph based on the state graph;
derive one or more first inferred statements based on connections between the instance graph and the state graph;
store the one or more first inferred statements with the first ABox statement; and
store the state graph and the first ABox statement in the property graph.

9. The system of claim 8, wherein the processor is further configured to execute the instructions to cause the system to predict one or more hidden facts based on statistics associated with the state graph, wherein a hidden fact is a probable future inferred statement as determined by the statistics.

10. The system of claim 8, wherein the instructions to generate, from the ontology, the simplified ontology is configured to pass the ontology to a reasoner to generate the set of sub conditions connected through logical operators.

11. The system of claim 8, wherein the instructions to create the state graph based on the simplified ontology is configured to:
create a non-empty power set of the set of sub conditions;
create one or more intermediate states for each element in the non-empty power set, wherein the intermediate states form a path from an original state of the ontology to an action state;
add one or more transition edges and transition edge condition between a first state N and a second state M when a first cardinality of the first state (cardinality (N)) is equal to a second cardinality of the second state plus 1 (cardinality (M)+1) and the second state M is in the first state N(M⊂N); and
add an action associated with the action state when the one or more intermediate states transitions to the action state.

12. The system of claim 8, wherein the instructions to add the first ABox statement into the instance graph based on the state graph is configured to:
apply a fact corresponding to a first entity and a second entity of the first ABox statement;
determine a first set of states of the first entity and a second set of states of the second entity;
for each state in the first set of states and the second set of states, determine whether the state satisfies an edge transition condition to second state in the state graph;
add the second state to the first set of states when the state is in the first set of states and satisfies the edge transition condition to the second state; and
add the second state to the second set of states when the state is in the second set of states and satisfies the edge transition condition to the second state.

13. The system of claim 12, wherein the instructions to derive the one or more first inferred statements based on the connections between the instance graph and the state graph is configured to add an inferred statement based on an action associated with the second state when the second state is an action state.

14. The system of claim 8, wherein the processor is further configured to execute the instructions to cause the system to:
receive a second ABox statement associated with the ontology;
add the second ABox statement to the instance graph;
derive one or more second inferred statements based on the connections between the instance graph and the state graph after being updated;
store the one or more second inferred statements with the second ABox statement; and
store the second ABox statement in the property graph.

15. A computer program product comprising computer-executable instructions stored on a non-transitory computer-readable storage medium, the computer-executable instructions when executed by a processor of a system, cause the system to:
generate, from an ontology, a simplified ontology comprising a set of sub-conditions connected through logical operators that are equivalent to the ontology;
create a state graph based on the simplified ontology;
receive a first assertion axiom (ABox) statement associated with the ontology;
add the first ABox statement to an instance graph based on the state graph;
derive one or more first inferred statements based on connections between the instance graph and the state graph after being updated;
store the one or more first inferred statements with the first ABox statement; and
store the state graph and the first ABox statement in the property graph.

16. The computer program product of claim 15, wherein the computer-executable instructions when executed by the processor of the system further causes the system to predict one or more hidden facts based on statistics associated with the state graph, wherein a hidden fact is a probable future inferred statement as determined by the statistics.

17. The computer program product of claim 15, wherein the instructions to generate, from the ontology, the simplified ontology is configured to pass the ontology to a reasoner to generate the set of sub conditions connected through logical operators.

18. The computer program product of claim 15, wherein the instructions to create the state graph based on the simplified ontology is configured to:
create a non-empty power set of the set of sub conditions;
create one or more intermediate states for each element in the non-empty power set, wherein the intermediate states form a path from an original state of the ontology to an action state;
add one or more transition edges and transition edge condition between a first state N and a second state M when a first cardinality of the first state (cardinality (N)) is equal to a second cardinality of the second state plus 1 (cardinality (M)+1) and the second state M is in the first state N(M⊂N); and
add an action associated with the action state when the one or more intermediate states transitions to the action state.

19. The computer program product of claim 15, wherein the instructions to add the first ABox statement into the instance graph based on the state graph is configured to:
apply a fact corresponding to a first entity and a second entity of the first ABox statement;
determine a first set of states of the first entity and a second set of states of the second entity;
for each state in the first set of states and the second set of states, determine whether the state satisfies an edge transition condition to second state in the state graph;
add the second state to the first set of states when the state is in the first set of states and satisfies the edge transition condition to the second state; and
add the second state to the second set of states when the state is in the second set of states and satisfies the edge transition condition to the second state.

20. The computer program product of claim 19, wherein the instructions to derive the one or more first inferred statements based on the connections between the instance graph and the state graph is configured to add an inferred statement based on an action associated with the second state when the second state is an action state.
